(19) United States
(12) Patent Application Publication
(10) Pub. No.: US 2008/0207162 A1
(43) Pub. Date: Aug. 28, 2008

(54) NOTIFICATION METHOD, NOTIFICATION SYSTEM, AND RECORDING MEDIUM HAVING NOTIFICATION PROGRAM

(75) Inventors: Hiroaki TAKEHARA, Kawasaki (JP); Tomohisa MISAWA, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/036,647

(22) Filed: Feb. 25, 2008

(30) Foreign Application Priority Data
Feb. 26, 2007 (JP) JP2007-045698

(51) Int. Cl. H04M 11/04

(52) U.S. Cl. 455/404.2

(57) ABSTRACT

A notification method performed by a computer that includes a helper-information management table having recorded thereon positional information designating locations of helpers in accordance with helper terminal devices owned by said helpers, and a juvenile-information management table having recorded thereon mobile-terminal identification information and facial photos of juveniles, said mobile-terminal identification information being used for uniquely designating each of mobile terminal devices owned by said juveniles.

### BACKGROUND OF THE INVENTION

### Field of the Invention

The present invention relates to a notification method for a user to notify a third person when the user feels he/she is in danger, a notification system for realizing such a notification method, and a recording medium having a notification program for allowing a computer to operate as the notification system.

### SUMMARY

A notification method performed by a computer that includes a helper-information management table having recorded thereon positional information designating locations of helpers in accordance with helper terminal devices owned by said helpers, and a juvenile-information management table having recorded thereon mobile-terminal identification information and facial photos of juveniles, said mobile-terminal identification information being used for uniquely designating each of mobile terminal devices owned by said juveniles.

### BRIEF DESCRIPTION OF THE DRAWINGS

FIG. 1 illustrates a computer network system according to an embodiment of the present invention;

FIG. 2 illustrates a notification control device;

FIG. 3 illustrates an example of a data structure of a juvenile-information management table;

FIG. 4 illustrates an example of a data structure of a helper-information management table;

FIG. 5a is a flow chart of a notification process executed by notification software;

FIG. 5b also shows the flow chart of the notification process executed by the notification software;

FIG. 6 is a flow chart of a notification-addressee determination subroutine;

FIG. 7 illustrates an example of a rescue request mail; and

FIG. 8 illustrates an example of a reply mail.

### DESCRIPTION OF THE PREFERRED EMBODIMENTS

An embodiment of the present invention will now be described in detail with reference to the attached drawings.

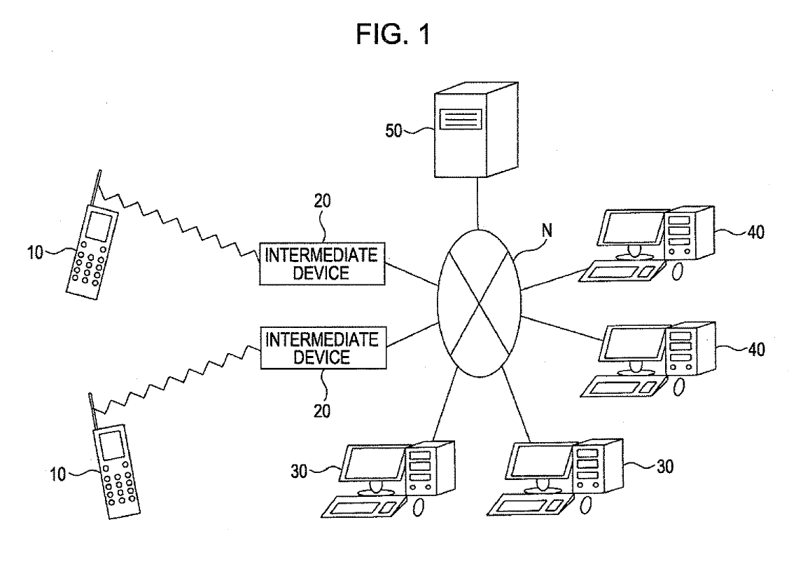

FIG. 1 illustrates a computer network system according to an embodiment of the present invention.

The computer network system according to this embodiment includes mobile terminal devices 10, intermediate devices 20, guardian terminal devices 30, helper terminal devices 40, and a notification control device 50. The devices 20 to 50, excluding the mobile terminal devices 10, are communicably connected to one another through a network N.

Each mobile terminal device 10 has a telephone function, an electronic-mail send/receive function, and a positioning function. More specifically, each mobile terminal device 10 is a mobile phone or a personal digital assistant (PDA). A positioning function is for obtaining the longitude and latitude of the current location as positional information based on information received from artificial satellites in the form of radio waves. The positional function is performed by hardware such as an antenna and software that generates positional information. The mobile terminal device 10 also has a function for sending a mobile phone number and positional information to the notification control device 50 when triggered by a predetermined operation performed by an operator, for example, a juvenile. This sending means may be defined by a program that sends an electronic mail containing the mobile phone number and positional information to the notification control device 50 or a program that sends the mobile phone number and positional information to the notification control device 50 through a phone line in the form of an electric signal. The triggering means may be defined by a mechanism that activates the program when a button provided on a surface of a housing is pressed by the operator, or a mechanism that activates the program when a built-in string is pulled. The mobile terminal device 10 may be connected to a flexible low-profile display device attached entirely over a cover of a backpack carried by a juvenile so as to have a function that outputs a predetermined image onto electronic paper contained in the low-profile display device.

Each intermediate device 20 intermediately transfers data between the corresponding mobile terminal device 10 and a computer (not shown) in the network N, and is set within a base station at each location. Each intermediate device 20 is equipped with several antennas (not shown) that are set on, for example, a utility pole or a rooftop of a building, and sends and receives data to and from the corresponding mobile terminal device 10 in the form of radio waves through the antennas.

The description of the embodiment below will be directed to a case where the operator is a juvenile.

Each guardian terminal device 30 and each helper terminal device 40 are general personal computers equipped with so-called mailers for sending and receiving electronic mails. A guardian terminal device 30 is a terminal device used by a juvenile's guardian, and a helper terminal device 40 is a terminal device used by a helper involved in rescue of a juvenile.

The notification control device 50 is a device for notifying an appropriate helper when a juvenile feels he/she is in danger and calls for help through his-her mobile terminal device 10.

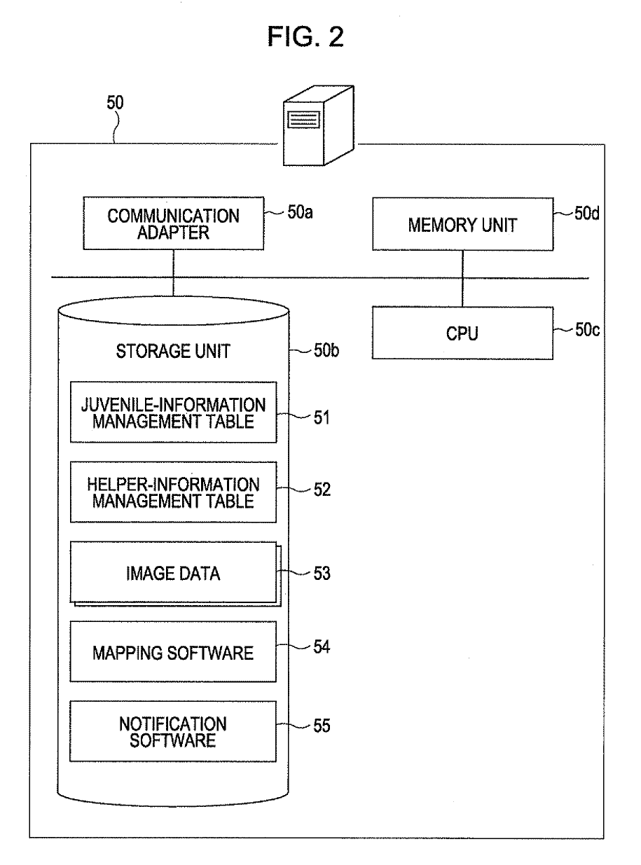

FIG. 2 illustrates the notification control device 50.

As shown in FIG. 2, the notification control device 50 is a general-purpose computer having installed therein two tables 51 and 52 and two pieces of software 54 and 55. Thus, the notification control device 50 contains a communication adapter 50a, a storage unit 50b, a central processing unit (CPU) 50c, and a memory unit 50d. The storage unit 50b has installed therein a juvenile-information management table 51, a helper-information management table 52, mapping software 54, and notification software 55.

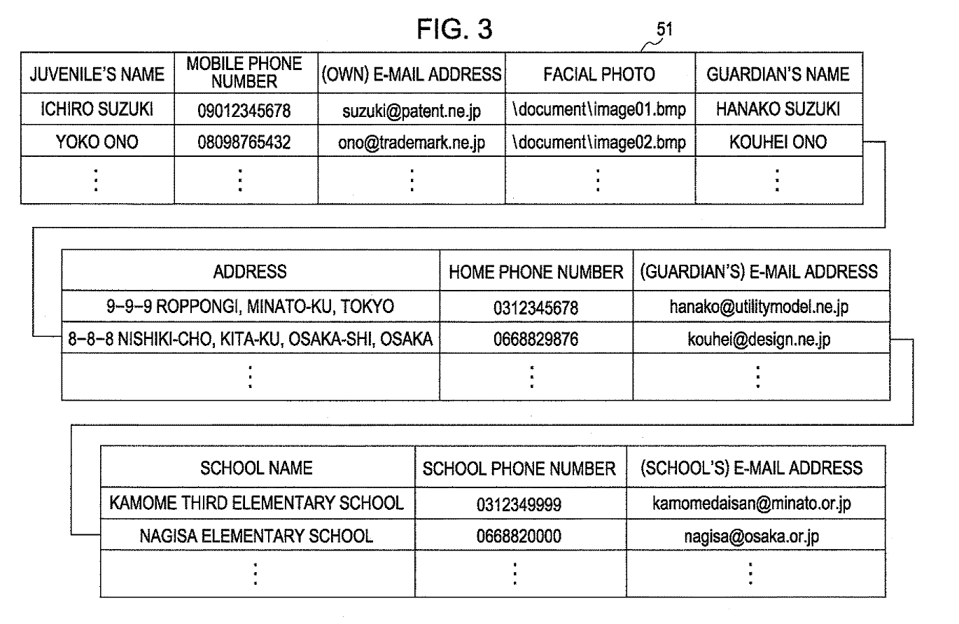

FIG. 3 illustrates an example of a data structure of the juvenile-information management table 51.

As shown in FIG. 3, each record on the juvenile-information management table 51 includes a “juvenile's name” field, a “mobile phone number” field, an “(operator) e-mail address” field, a “facial photo” field, a “guardian's name” field, an “address” field, a “home phone number” field, a “(guardian's) e-mail address” field, a “school name” field, a “school phone number” field, and a “(school's) e-mail address” field. The “juvenile's name” field is for recording the name of each juvenile. The “mobile phone number” field and the “(operator) e-mail address” field are for recording the phone number and the electronic mail address of the mobile terminal device 10 owned by the juvenile, respectively. The “facial photo” field is for recording storage-position information such as a path that designates the storage position of image data for displaying the juvenile's facial photo. The “guardian's name” field is for recording the name of the juvenile's guardian. The “address” field and the “home phone number” field are for recording the juvenile's and guardian's home address and phone number, respectively. The “(guardian's) e-mail address” field is for recording the electronic mail address of the guardian terminal device 30 at the juvenile's and guardian's home. The “school name” field and the “school phone number” field are for recording the name and phone number of the school to which the juvenile belongs, respectively. The “(school's) e-mail address” field is for recording the electronic mail address of a terminal device (not shown) at the juvenile's school.

A step performed by the notification control device 50 for storing information related to each juvenile in the juvenile-information management table 51 corresponds to a second storing step.

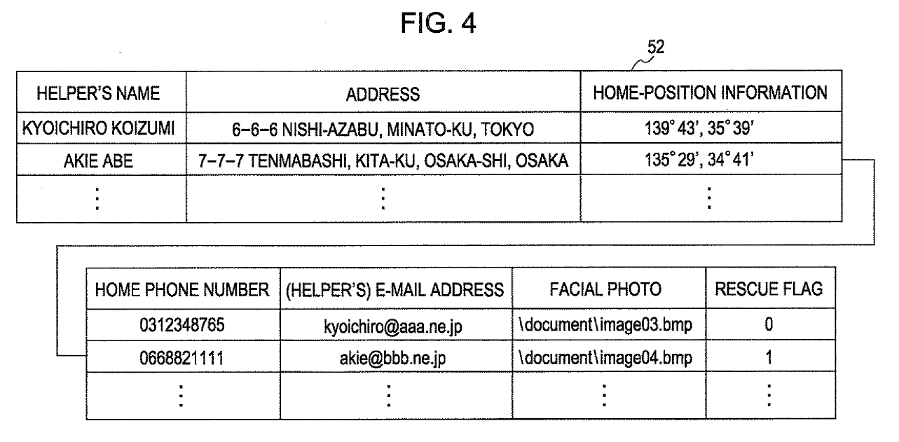

FIG. 4 illustrates an example of a data structure of the helper-information management table 52.

As shown in FIG. 4, each record on the helper-information management table 52 includes a “helper's name” field, an “address” field, a “home-position information” field, a “home phone number” field, a “(helper's) e-mail address” field, a “facial photo” field, and a “rescue flag” field. The “helper's name, field is for recording the name of each helper. The “address” field and the “home phone number” field are for recording the helper's home address and phone number, respectively. The “home-position information” field is for recording the longitude and latitude of the position of the helper's home. The “(helper's) e-mail address” field is for recording the electronic mail address of the helper terminal device 40 at the helper's home. The “facial photo” field is for recording storage-position information such as a path that designates the storage position of image data for displaying the helper's facial photo. The “rescue flag” field is for recording a rescue flag that indicates whether or not the helper is capable of rescuing a juvenile. If the helper plans to go on a trip, for example, and will thus be away from home for a long period of time, the helper can operate a predetermined function in the helper terminal device 40 so as to switch the rescue flag from “0” mode, indicating that the helper is capable of rescuing a juvenile, to “1” mode indicating that the helper is not capable of rescuing a juvenile.

A step performed by the notification control device 50 for storing information related to each helper in the helper-information management table 52 corresponds to a first storing step.

When receiving the scale and positional information, the mapping software 54 creates a map image of an area around the position designated by the positional information with the given scale, and displays the map image. This mapping software 54 is commonly known software and will therefore not be described here in detail.

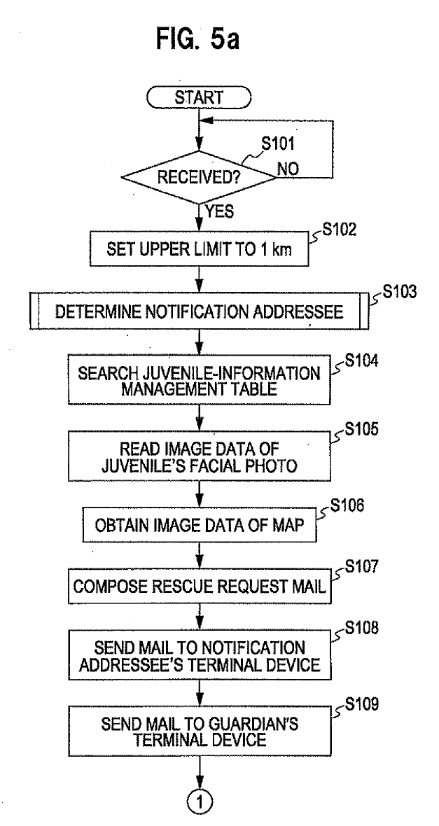

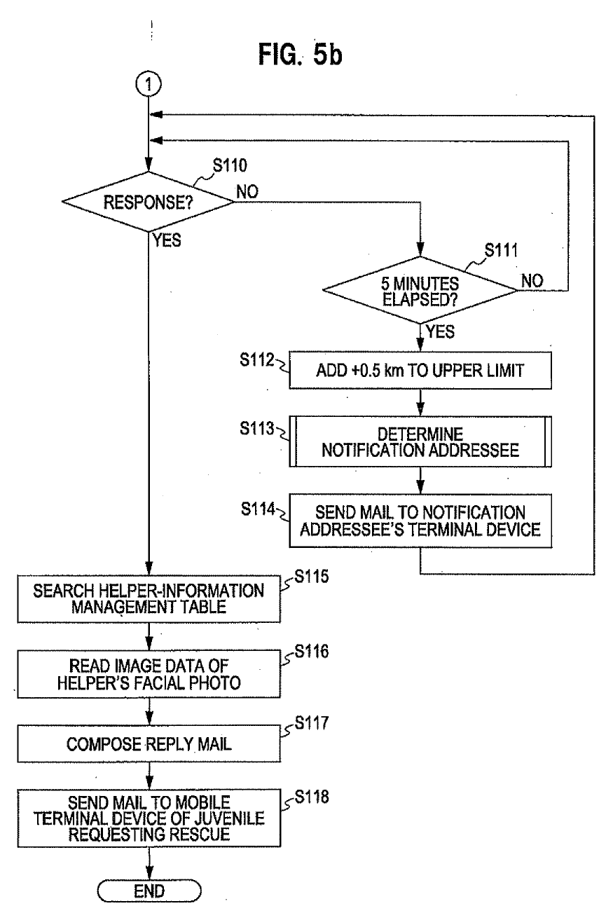

The notification software 55 is a program for notifying an appropriate helper when a juvenile feels he/she is in danger and calls for help through his-her mobile terminal device 10. The notification software 55 includes a module program for realizing an electronic-mail send/receive function. When the main power supply is input to the notification control device 50, the notification software 55 is activated by the CPU 50c. A notification process that the CPU 50c executes in accordance with the notification software 55 will be described hereinafter with reference to FIGS. 5A and 5B.

FIGS. 5a and 5b show a flow chart of the notification process executed by the notification software 55.

After the notification process is started, the CPU 50c waits until a mobile phone number and positional information are sent from any one of the mobile terminal devices 10 in step S101. When a mobile phone number and positional information are received from one of the mobile terminal devices 10, the CPU 50c allows the process to proceed to step S102.

Here, step S101 corresponds to a receiving step.

In step S102, the CPU 50c sets the upper limit to 1 km, which is to be used in a determining substep (S202) included in a notification-addressee determination subroutine in step S103.

In step S103, the CPU 50c executes the notification-addressee determination subroutine.

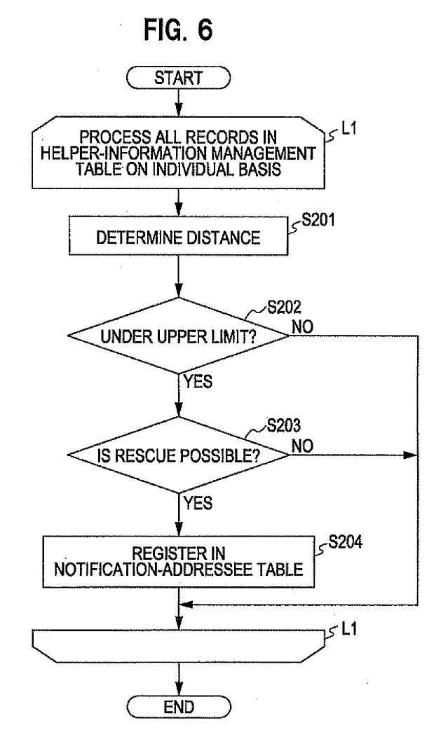

FIG. 6 is a flow chart of the notification-addressee determination subroutine.

After the notification-addressee determination subroutine is started, the CPU 50c performs a first process loop L1. In the first process loop L1, the CPU 50c performs substeps S201 to S204 for all the records included in the helper-information management table 52 shown in FIG. 4.

Specifically, in substep S201, the CPU 50c calculates a distance on the basis of the positional information received in step S101 and the positional information in the “home-position information” field of each record being processed.

In substep S202, the CPU 50c determines whether or not the distance calculated in substep S201 is below the currently set upper limit. If the distance calculated in substep S201 is above or equal to the currently set upper limit, the CPU 50c allows the process to diverge from substep S202 and to end for the record currently being processed. On the other hand, if the distance calculated in substep S201 is below the currently set upper limit, the CPU 50c allows the process to proceed to substep S203.

In substep S203, the CPU 50c determines whether or not the value in “rescue flag” field of the record being processed is set at “0” indicating the rescuable mode. If the value in “rescue flag” field of the record being processed is set at “1” indicating the non-rescuable mode, the CPU 50c allows the process to diverge from substep S203 and to end for the record currently being processed. On the other hand, if the value in “rescue flag” field of the record being processed is set at “0” indicating the rescuable mode, the CPU 50c allows the process to proceed to substep S204.

In substep S204, the CPU 50c registers the values in the “helper's name” field and the “(helper's) e-mail address” field of the record being processed into a notification-addressee table as a single record. Subsequently, the CPU 50c ends the process for this record.

After performing substeps S201 to S204 for all the records included in the helper-information management table 52 shown in FIG. 4 to finish creating the notification-addressee table, the CPU 50c withdraws from the first process loop L1 and ends the notification-addressee determination subroutine shown in FIG. 6. The CPU 50c then allows the process to proceed to step S104 in FIG. 5a.

The first process loop L1 corresponds to a calculating step and an extracting step.

In step S104, the CPU 50c searches the juvenile-information management table 51 using the mobile phone number received in step S101 as a search condition. When an appropriate record is found from the juvenile-information management table 51, the CPU 50c allows the process to proceed to step S105.

Step S104 corresponds to a reading step.

In step S105, the CPU 50c reads image data designated by the value in “facial photo” field of the record found in step S104.

In step S106, the CPU 50c activates the mapping software 54 and sends the positional information received in step S101 and information designating a predetermined scale to the mapping software 54, so as to obtain image data of a map from the mapping software 54 as a return value.

In step S107, the CPU 50c composes a rescue request mail, which is an electronic mail with a message written thereon requesting rescue. This rescue request mail contains the image data read in step S105 and the image data obtained in step S106.

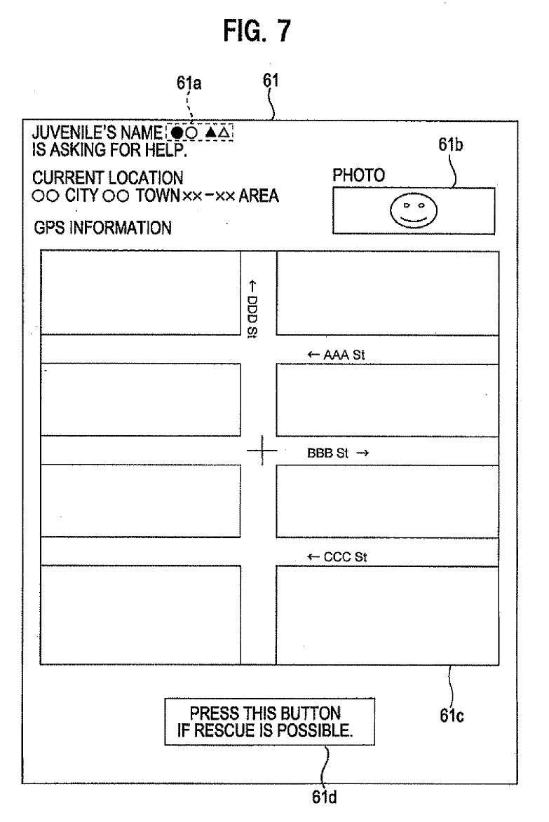

FIG. 7 illustrates an example of a rescue request mail 61.

As shown in FIG. 7, the rescue request mail 61 contains a name 61a of the owner (juvenile) of the mobile terminal device 10, which is the original sender of the mobile phone number and the positional information received in step S101. The rescue request mail 61 also contains a facial photo image 61b of the juvenile and a map image 61c of an area around the current location of the juvenile's mobile terminal device 10. Moreover, the rescue request mail 61 contains a rescue button 61d, which is to be clicked by a helper when the helper decides to rescue the juvenile. When the rescue button 61d is clicked, an electronic mail is sent to the notification control device 50 as a response.

After composing the rescue request mail 61 displaying the content shown in FIG. 7, the CPU 50c allows the process to proceed to step S108 (FIG. 5A).

Steps S105 to S107 correspond to a composing step.

In step S108, the CPU 50c sends the rescue request mail 61 composed in step S108 to all electronic mail addresses recorded in the notification-addressee table created in the notification-addressee determination subroutine in step S103.

In step S109, the CPU 50c sends the rescue request mail 61 composed in step S108 to electronic mail addresses indicated by the values in the “(guardian's) e-mail address” field and “(school's) e-mail address” field of the record found in step S104. The rescue request mail 61 to be sent to the guardian terminal device 30 and to a terminal device (not shown) at the school does not necessarily have to contain the rescue button 61d.

Step S109 corresponds to a sending step.

In step S110 (FIG. 5B), the CPU 50c determines whether or not a response electronic mail is received from any one of the helper terminal devices 40 to which the rescue request mail 61 was sent in step S108. More specifically, a response electronic mail can be sent from a helper terminal device 40 in response to clicking of the rescue button 61d. If no response electronic mail is received from any of the helper terminal devices 40, the CPU 50c allows the process to proceed from step S110 to step S111.

In step S111, the CPU 50c determines whether or not five minutes, for example, have elapsed after sending the rescue request mail 61. If five minutes have not elapsed after sending the rescue request mail 61, the CPU 50c allows the process to diverge from step S111 and to return to step S110.

During the process loop of step S110 and step S111, if five minutes have elapsed after sending the rescue request mail 61, the CPU 50c allows the process to proceed from step S111 to step S112.

In step S112, the CPU 50c adds +0.5 km, for example, to the value set as the upper limit and uses this new upper limit value for a determining step (substep S202) included in a notification-addressee determination subroutine in step S113.

In step S113, the CPU 50c executes the notification-addressee determination subroutine. The content of this notification-addressee determination subroutine is already described above with reference to FIG. 6 and will not be repeated. After executing the notification-addressee determination subroutine to finish creating a notification-addressee table, the CPU 50c allows the process to proceed to step S114.

Steps S110 to S113 correspond to a re-extracting step.

In step S114, the CPU 50c sends the rescue request mail 61 composed in step S108 to all electronic mail addresses recorded in the notification-addressee table created in the notification-addressee determination subroutine in step S113. Subsequently, the CPU 50c allows the process to return to step S110.

Step S114 corresponds to a re-sending step.

On the other hand, during the process loop of step S110 and step S111, if a response electronic mail is received from any one of the helper terminal devices 40, the CPU 50c allows the process to proceed from step S110 to step S115.

In step S115, the CPU 50c searches the helper-information management table 52 in FIG. 4 using the electronic mail address of the sender of the response mail received in step S110 as a search condition. When an appropriate record is found from the helper-information management table 52, the CPU 50c allows the process to proceed to step S116.

Step S110 corresponds to a second receiving step, and step S115 corresponds to a second reading step.

In step S116, the CPU 50c reads image data designated by the value of the “facial photo” field in the record found in step S115.

In step S117, the CPU 50c composes a reply mail, which is an electronic mail with a message written thereon indicating that a helper is coming to rescue. This reply mail contains the image data read in step S116.

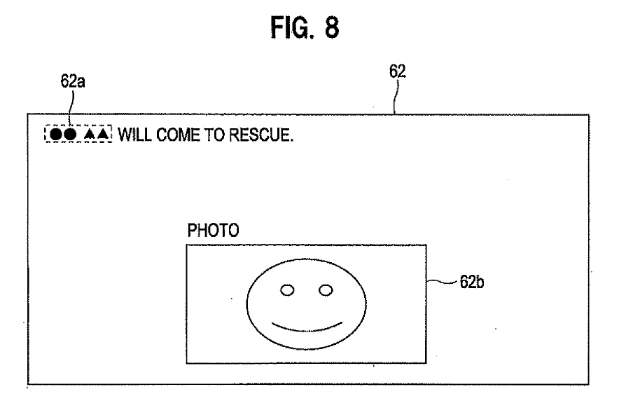

FIG. 8 illustrates an example of such a reply mail 62.

As shown in FIG. 8, the reply mail 62 contains a name 62a of a helper corresponding to the value in “helper's name” field of the record found in step S115. The reply mail 62 also contains a facial photo image 62b of the helper.

After composing the reply mail 62 displaying the content shown in FIG. 8, the CPU 50c allows the process to proceed to step S118.

Steps S116 and S117 correspond to a second composing step.

In step S118, the CPU 50c sends the reply mail 62 composed in step S117 to the mobile terminal device 10 which is the original sender of the mobile phone number and the positional information received in step S101. Finally, the CPU 50c completes the notification process according to FIGS. 5a and 5b.

Step 118 corresponds to a second sending step.

The reply mail 62 sent to the juvenile's mobile terminal device 10 is displayed on a display of the mobile terminal device 10. In this case, if the mobile terminal device 10 is connected to a flexible low-profile display device attached over a cover of a backpack carried by the juvenile, the mobile terminal device 10 may output a predetermined image onto electronic paper contained in the low-profile display device.

Although the communication among the terminal devices are implemented by means of electronic mails in the above description, the communication may be implemented by other means, such as a short message service using phone numbers. If such a short message service is employed, mobile-terminal identification information in the juvenile-information management table 51 will be mobile phone numbers.

In the computer network system according to this embodiment having the above-described configuration, if a juvenile feels he/she is in danger, the juvenile may operate the triggering means (press a button or pull a string) of his/her own mobile terminal device 10. Then, a rescue request mail 61 as shown in FIG. 7 is sent to a helper terminal device 40 of a helper whose home is located within 1 km, for example, of the current location of the juvenile's mobile terminal device 10 (steps S101 to S108). Since the rescue request mail 61 contains the facial photo image 61b of the juvenile, the helper can immediately know which juvenile to rescue.

Of the helpers having received the rescue request mail 61 in their helper terminal devices 40, a helper that can come to rescue the juvenile may click the rescue button 61d contained in the rescue request mail 61. Then, a reply mail 62 as shown in FIG. 8 is sent to the juvenile's mobile terminal device 10 (YES in step S110, and steps S115 to S118). Since the reply mail 62 contains the facial photo image 62b of the helper coming to rescue, the juvenile requesting rescue can immediately know which helper is coming to rescue.

If there is no response from any of the helper terminal devices 40 to which the rescue request mail 61 was sent, the notification control device 50 increases the notification-addressee search range by 0.5 km, for example, every five minutes in order to increase the number of notification addressees to which the rescue request mail 61 is sent (NO in step S110, and steps S111 to S114). Accordingly, even if there are no helpers near the juvenile who are capable of coming to rescue the juvenile, it is possible to call for help to helpers located slightly distant from the juvenile.

In addition, according to this embodiment, if the mobile terminal device 10 owned by the juvenile is connected to a flexible low-profile display device attached entirely over a cover of a backpack carried by the juvenile, a predetermined image (such as an image having the content “HELP!” written thereon) can be displayed on electronic paper contained in the low-profile display device when the mobile terminal device 10 receives the reply mail 62. In this manner, the helper coming to rescue the juvenile can immediately find the juvenile.

What is claimed is:

1. A notification method performed by a computer that includes a helper-information management table having recorded thereon positional information designating locations of helpers in accordance with helper terminal devices owned by said helpers, and a juvenile-information management table having recorded thereon mobile-terminal identification information and facial photos of juveniles, said mobile-terminal identification information being used for uniquely designating each of mobile terminal devices owned by said juveniles, said notification method comprising
a receiving step for receiving said mobile-terminal identification information of any one of said mobile terminal devices and positional information designating a location of said mobile terminal device, said mobile-terminal identification information and said positional information being received through a communication device;
an extracting step for referring to said helper-information management table in order to extract at least one of said helper terminal devices, said at least one helper terminal device being located within a predetermined range from said location designated by said positional information received in said receiving step; and
a sending step for sending image data corresponding to said mobile-terminal identification information received in said receiving step to said at least one helper terminal device extracted in said extracting step, said image data being sent through said communication device.

2. The notification method according to claim 1, wherein said helper-information management table contains image data of each of said helpers, and
wherein said notification method further comprises a second sending step for sending said image data of said helper corresponding to said at least one helper terminal device to said mobile terminal device through said communication device by referring to said helper-information management table upon receiving a response from said at least one helper terminal device through said communication device.

3. A notification system comprising:
a helper-information management table having recorded thereon positional information designating locations of helpers in accordance with helper terminal devices owned by said helpers;
a juvenile-information management table having recorded thereon mobile-terminal identification information and facial photos of juveniles, said mobile-terminal identification information being used for uniquely designating each of mobile terminal devices owned by said juveniles;
a receiving portion that receives said mobile-terminal identification information of any one of said mobile terminal devices and positional information designating a location of said mobile terminal device, said receiving portion receiving said mobile-terminal identification information and said positional information through a communication device;
an extracting portion that refers to said helper-information management table in order to extract at least one of said helper terminal devices, said at least one helper terminal device being located within a predetermined range from said location designated by said positional information received at said receiving portion; and
a sending portion that sends image data corresponding to said mobile-terminal identification information received at said receiving portion to said at least one helper terminal device extracted at said extracting portion, said sending portion sending said image data through said communication device.

4. The notification system according to claim 3 wherein said helper-information management table contains image data of each of said helpers, and
wherein said notification system further comprises a second sending portion that sends said image data of said helper corresponding to said at least one helper terminal device to said mobile terminal device through said communication device by referring to said helper-information management table upon receiving a response from said at least one helper terminal device through said communication device.

5. A recording medium having a notification program recorded thereon that is readable by a computer, said recording medium allowing said computer to function as:
a helper-information management table having recorded thereon positional information designating locations of helpers in accordance with helper terminal devices owned by said helpers;
a juvenile-information management table having recorded thereon mobile-terminal identification information and facial photos of juveniles, said mobile-terminal identification information being used for uniquely designating each of mobile terminal devices owned by said juveniles;
receiving means that receives said mobile-terminal identification information of any one of said mobile terminal devices and positional information designating a location of said mobile terminal device, said receiving means receiving said mobile-terminal identification information and said positional information through a communication device;
extracting means that refers to said helper-information management table in order to extract at least one of said helper terminal devices, said at least one helper terminal device being located within a predetermined range from said location designated by said positional information received at said receiving means; and
sending means that sends image data corresponding to said mobile-terminal identification information received at said receiving means to said at least one helper terminal device extracted at said extracting means, said sending means sending said image data through said communication device.

6. The recording medium according to claim 5, wherein said helper-information management table contains image data of each of said helpers, and
wherein said recording medium further allows said computer to function as second sending means that sends said image data of said helper corresponding to said at least one helper terminal device to said mobile terminal device through said communication device by referring to said helper-information management table upon receiving a response from said at least one helper terminal device through said communication device.

7. A notification method performed by a computer comprising:
receiving mobile-terminal identification information and positional information designating a location of a mobile terminal device;
extracting at least one helper terminal devices, said at least one helper terminal device being located within a predetermined range from said location; and
sending image data corresponding to said mobile-terminal identification information to said at least one helper terminal device.
